(19) United States
(12) Patent Application Publication
(10) Pub. No.: US 2009/0108051 A1
(43) Pub. Date: Apr. 30, 2009

(54) Method for joining components

(75) Inventors: Joachim Bamberg, Dachau (DE); Wilhelm Satzger, Muenchen (DE); Dieter Schneefeld, Walkertshofen (DE); Dietmar Helm, Karlsfeld (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/290,175

(22) Filed: Oct. 28, 2008

(30) Foreign Application Priority Data
Oct. 29, 2007 (DE) DE 102007051577.6

(51) Int. Cl. B23K 20/12

(52) U.S. Cl. 228/112.1

(57) ABSTRACT

A method for joining components is described, in particular, for joining a rotor blade to a rotor base member when manufacturing and/or repairing an integrally bladed gas turbine rotor. The method includes the following steps: providing two components to be assembled, respectively joined to one another; providing a joining part; mutually aligning the two components to be assembled and the joining part such that the joining part is positioned as an insert between the two components to be assembled; driving the two components being assembled with the joining part being interposed therebetween in that the joining part to execute a linear, reciprocating motion in opposition to the two stationary components to be assembled in order to generate the frictional motion, further comprising exerting an upsetting force via the joining part on the joint zones between the two stationary components and the joining part, namely in a direction that extends essentially perpendicularly to the frictional motion.

This application claims priority to German Patent Application DE 10 2007 051 577.6, filed Oct. 29, 2007, which is incorporated by reference herein.

### FIELD OF INVENTION

The present invention relates to a method for joining components, in particular, for joining a rotor blade to a rotor base member when manufacturing or repairing an integrally bladed gas turbine rotor.

### BACKGROUND

In the manufacture of gas turbines, friction welding is a widely used joining method. Friction welding counts among what are commonly referred to as pressure welding methods; in the case of friction welding, the distinction being made, inter alia, among what are commonly referred to as linear friction welding, rotary friction welding, and friction stir welding. In the case of friction welding, components are joined to one another, respectively, bonded together by friction. In linear friction welding, one component is driven to execute a reciprocating translational motion, while the other component is stationary and is pressed with a defined force against the moving component. In this case, the joining surfaces of the components to be bonded together are mutually adapted by hot forging.

In the known related-art procedure for bonding or joining components through the use of linear friction welding, two components to be assembled are rubbed directly against each other, one component being driven to execute a reciprocating translational motion, and a defined upsetting pressure being preferably exerted via the other component on the joining surface between the two components. If the two components to be assembled are rubbed directly against each other, then complex clamping devices are needed, particularly on the moving components. The components to be assembled can be subject to deformations. Moreover, the frictional motion executed by the components to be assembled exposes joining surfaces in the area of the joining zone that are potentially subject to contamination, for example by oxygen. This can degrade the quality of the joint. Moreover, the linear friction-welding procedure known from the related art requires that the linearly reciprocated component be driven toward zero amplitude at the end of the welding operation, and, in fact, in precise alignment with the stationary component. The precision to be observed is on the order of 0.1 mm. Given the existing masses and forces, this precision can only be observed with difficulty, respectively by entailing substantial outlay.

To avoid the above disadvantages, it is already known from the related art in accordance with the German Patent Application DE 10 2005 019 356 A1 to provide a joining part in addition to the two components to be assembled, respectively joined to one another, the two components to be assembled and the joining part being mutually aligned in such a way that the joining part is positioned as an insert between the two components to be assembled, and the two components being assembled with the joining part being interposed therebetween in that the joining part is driven to execute a linear, reciprocating motion in opposition to the two stationary components to be assembled in order to generate the frictional motion, and, in particular, in that an upsetting force is exerted via both stationary components on the joint zones between the two stationary components and the joining part. Accordingly, this method requires displacing at least one of the components to be assembled, respectively joined to one another, in order to produce the upsetting force.

### SUMMARY OF THE INVENTION

Against this background, an object of the present invention is to devise an improved method for joining components. This objective is achieved by a method for joining components comprising providing two components to be assembled, respectively joined to one another; providing a joining part; mutually aligning the two components to be assembled and the joining part such that the joining part is positioned as an insert between the two components to be assembled; driving the two components being assembled with the joining part being interposed therebetween in that the joining part to execute a linear, reciprocating motion in opposition to the two stationary components to be assembled in order to generate the frictional motion; further comprising exerting an upsetting force via the joining part on the joint zones between the two stationary components and the joining part, namely in a direction that extends essentially perpendicularly to the frictional motion. In accordance with the present invention, the upsetting force is exerted via the joining part between the two stationary components and the joining part, namely in a direction that extends essentially perpendicularly to the frictional motion.

In accordance with the method of the present invention, the joining part produces the frictional motion required for linear friction welding, on the one hand, and the requisite upsetting force, on the other hand. Accordingly, there is no need to displace the two components to be assembled, respectively joined to one another, in order to produce the frictional motion or to exert the upsetting force. The precision of the linear friction welding may be hereby further enhanced over the related art.

A joining part is used which has at least one joining surface that extends obliquely relative to the upsetting force direction. Preferably, both joining surfaces of the joining part extend obliquely relative to the upsetting force direction, namely they converge in a wedge shape in the upsetting force direction.

### BRIEF DESCRIPTION OF THE DRAWINGS

The present invention is described in greater detail in the following on the basis of exemplary embodiments, without being limited thereto. Reference is made to the drawing, whose:

FIG. 1: shows a view of two components and one joining part to be assembled along the lines of the method according to the present invention; and

FIG. 2: shows a view that is rotated by approximately 90° relative to FIG. 1.

### DETAILED DESCRIPTION

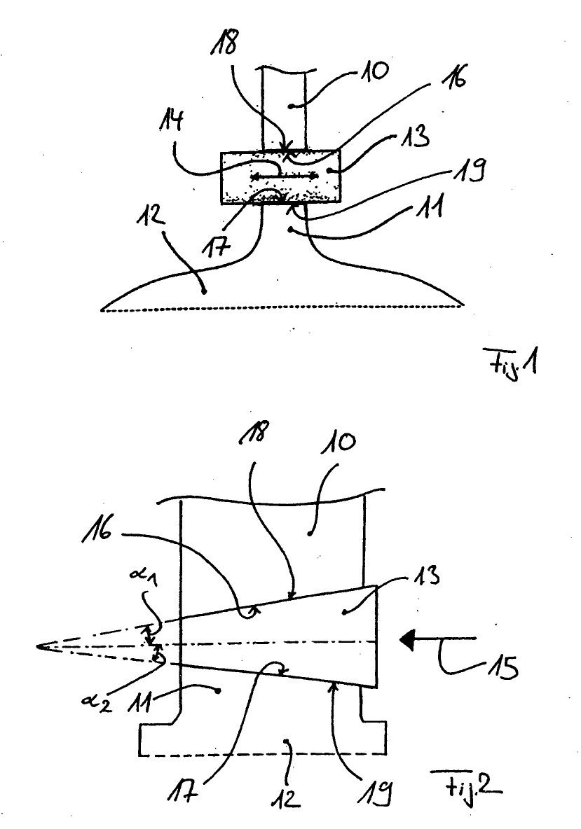

The present invention relates to a method for joining components through the use of linear friction welding. In the following, the present invention is described with reference to FIGS. 1 and 2 for the preferred application case of the method according to the present invention, where a blade 10 of a rotor blade is to be joined to a hump-like elevation 11 of a rotor base member 12 in order to manufacture or repair an integrally bladed gas turbine rotor.

Besides the two components to be joined to one another, thus blade 10 of the rotor blade and rotor base member 12, the method according to the present invention also provides a joining part 13. The two components to be joined to one another, as well as joining part 13 are mutually aligned in such a way that joining part 13 is positioned as an insert between the two components to be assembled, thus blade 10 and hump-like elevation 11 of rotor base member 12.

The two components are assembled with joining part 13 being interposed therebetween, namely in that joining part 13 is driven to execute a linear, reciprocating motion in the direction of double arrow 14 (see FIG. 1) in order to generate a frictional motion required for linear friction welding. In this context, in accordance with FIG. 1, this frictional motion is effected approximately tangentially to the circumferential direction of rotor base member 12. In addition, an upsetting force in the direction of arrow 15 (see FIG. 2) is produced via joining part 13, namely is exerted on joining zones between joining part 13 and blade 10, as well as hump-like elevation 11. In this context, in accordance with FIG. 2, upsetting force 15 is produced in a direction extending essentially perpendicularly to the frictional motion (arrow 14); in accordance with FIG. 2, essentially in the axial direction of rotor base member 12.

In accordance with the present invention, joining part 13 has at least one joining surface extending obliquely relative to the upsetting force direction (arrow 15). In the illustrated exemplary embodiment, both joining surfaces 16, 17 of joining part 13 are inclined relative to the upsetting force direction, the two joining surfaces 16, 17 of joining part 13 converging in a wedge shape in upsetting force direction (arrow 15). Joining surfaces 18, 19 of blade 10, as well as of hump-like elevation 11, which adjoin joining surfaces 16, 17 of joining part 13, are likewise inclined relative to the upsetting force direction.

In accordance with FIG. 2, joining surface 16 of joining part 13 forms an angle of α₁ with the upsetting force direction, and joining surface 17 of joining part 13, an angle of α₂ with the upsetting force direction. In this context, the two angles α₁ and α₂ are preferably within a range of between 15° and 45°. The two angles α₁ and α₂ may be either equal or different in absolute value.

Joining part 13 features an over-allowance relative to the two components to be assembled. Once the friction welding is carried out, a postworking then follows in which material is removed in order to produce the desired final contour. Accordingly, when implementing the method according to the present invention, both blade 10 of the rotor blade, as well as rotor base member 12 and, thus, hump-like elevation 11 of the same are immovably fixed in position. It is merely necessary for joining part 13 to be driven to execute a reciprocating translational motion in the direction of double arrow 14 to produce the frictional motion, and to subsequently produce the upsetting force in the direction of arrow 15.

### LIST OF REFERENCE NUMERALS

10 blade
11 hump-like elevation
12 rotor base member
13 joining part
14 frictional motion
15 upsetting force direction
16 joining surface
17 joining surface
18 joining surface
19 joining surface

What is claimed is:

1. A method for joining components comprising:
providing two components to be assembled;
providing a joining part;
mutually aligning the two components to be assembled and the joining part such that the joining part is positioned as an insert between the two components to be assembled;
driving the joining part to execute a linear, reciprocating motion in opposition to the two stationary components to be assembled in order to generate the frictional motion,
further comprising exerting an upsetting force via the joining part on the joint zones between the two stationary components and the joining part, namely in a direction that extends essentially perpendicularly to the frictional motion.

2. The method as recited in claim 1, wherein the two components to be assembled are a rotor blade and rotor base member of an integrally bladed gas turbine rotor.

3. The method as recited in claim 1, further comprising using a joining part which has at least one joining surface that extends obliquely relative to the upsetting force direction.

4. The method as recited in claim 1, further comprising using a joining part which has two joining surfaces that extend obliquely relative to the upsetting force direction.

5. The method as recited in claim 1, further converging joining surfaces of the joining part in a wedge shape in the upsetting force direction.

6. The method as recited in claim 1, further comprising inclining joining surfaces of the joining part in the upsetting force direction at angles that differ in absolute value.

7. The method as recited in claim 1, further comprising inclining joining surfaces of the joining part in the upsetting force direction at angles that are equal in absolute value.

8. The method as recited in claim 1, further comprising obliquely extending joining surfaces of the joining part to form an angle of between 15° and 45° with the upsetting force direction.

9. The method as recited in claim 1,
wherein, when manufacturing and/or repairing an integrally bladed gas turbine rotor, providing a blade and a rotor base member as components to be assembled, driving the joining part to execute a reciprocating translational, respectively linear motion in opposition to the rotor base member, and the blade in a direction that extends essentially tangentially to the circumferential direction of rotor base member, and providing the upsetting force direction by the joining part essentially in the axial direction of the rotor base member.
